(19) United States
(12) Patent Application Publication
(10) Pub. No.: US 2015/0007346 A1
(43) Pub. Date: Jan. 1, 2015

(54) PROTECTING CONFIDENTIAL CONTENT IN A USER INTERFACE

(71) Applicant: International Business Machines Corporation, Armonk, NY (US)

(72) Inventors: David J. Delia, Legrangeville, NY (US); Wayne M. Delia, POUGHKEEPSIE, NY (US); Franco Motika, Hopewell Junction, NY (US)

(21) Appl. No.: 13/927,176

(22) Filed: Jun. 26, 2013

(51) Int. Cl. G06F 21/62

(52) U.S. Cl. CPC G06F 21/6209
USPC 726/28

(57) ABSTRACT

Embodiments of the present invention disclose a method, computer program product, and system for protecting confidential information in a document displayed in a user interface. A computer displays in the user interface a non-confidential part of the document without displaying a confidential part of the document and without displaying any indication that the document includes the confidential part. While the computer displays the non-confidential part of the document without displaying the confidential part of the document and without displaying any indication that the document includes the confidential part, the computer receives from a user authentication information and a request for display of the confidential part of the document, if any, and in response to the authentication information and the request, the computer displaying the confidential part of the document along with the non-confidential part of the document.

### FIELD OF THE INVENTION

The present invention relates generally to the field of computer security, and more specifically to protecting confidential content.

### BACKGROUND OF THE INVENTION

A user interface can include a variety of content items (e.g., emails, documents, folders) that can be confidential or not confidential. In many instances, user interfaces that include confidential content items are password protected with a corresponding password entry screen. Password entry screens indicate that a password or another form of authentication credential (e.g., biometric credential) needs to be input and validated in order to access confidential content items. When a proper authentication credential is input and verified in the password entry screen, the user interface displays all content items (confidential and not confidential). Presentation of a password entry screen indicates a presence of confidential content, which can lead to unauthorized attempts to access confidential content items in the user interface. Unauthorized attempts to access confidential content are typically initiated when a password entry screen is presented.

It was known to protect web based applications from Cross Site Request Forgery (CSRF) attacks by U.S. Pat. No. 8,020,193 B2 by Bhola et al., which teaches classification of resources offered by a web server application as CSRF-protected resources or not-CSRF-protected resources, and providing CSRF protection to web applications. Each resource offered by a web server application is classified as a CSRF-protected resource or not-CSRF-protected resource. Then a user authentication is performed, and an authentication token initialized. A CSRF protection secret is also initialized to validate CSRF protection parameters contained in resource identifiers. A server side or client side rewriting process is performed to add the CSRF protection parameter to the resource identifiers.

### SUMMARY

Embodiments of the present invention disclose a method, computer program product, and system for protecting confidential information in a document displayed in a user interface. A computer displays in the user interface a non-confidential part of the document without displaying a confidential part of the document and without displaying any indication that the document includes the confidential part. While the computer displays the non-confidential part of the document without displaying the confidential part of the document and without displaying any indication that the document includes the confidential part, the computer receives from a user authentication information and a request for display of the confidential part of the document, if any, and in response to the authentication information and the request, the computer displaying the confidential part of the document along with the non-confidential part of the document. In another embodiment, the document is a list of emails received by the user, a list of documents, or a list of file folders.

### BRIEF DESCRIPTION OF THE SEVERAL VIEWS OF THE DRAWINGS

FIG. 1 is a functional block diagram of a content protection system in accordance with an embodiment of the present invention.

FIG. 2 is a flowchart of operational steps of a configuration program of FIG. 1 for configuring a user interface that can include protected and unprotected content items, in accordance with an embodiment of the present invention.

FIG. 3 is a flowchart of operational steps of a content protection program of FIG. 1 for managing display of protected and unprotected content items in a user interface, in accordance with an embodiment of the present invention.

FIGS. 4 A, B, and C are exemplary depictions of user interfaces displaying unprotected and protected content items, in accordance with an embodiment of the present invention.

FIG. 5 is a block diagram of components of the computers of FIG. 1.

### DETAILED DESCRIPTION

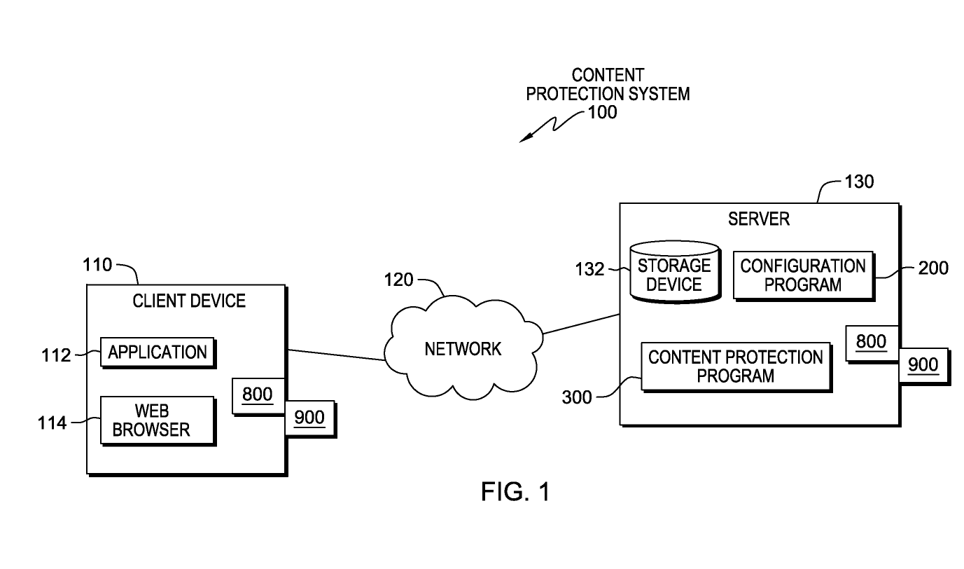

The present invention will now be described in detail with reference to the Figures. FIG. 1 is a functional block diagram illustrating content protection system 100, in accordance with one embodiment of the present invention.

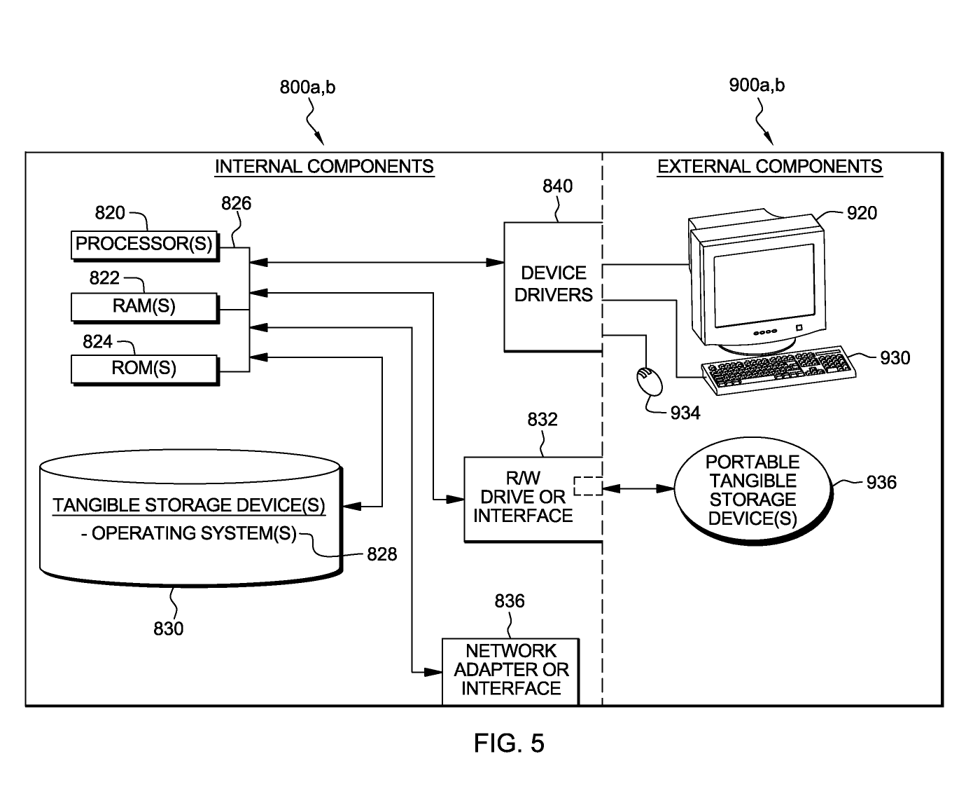

Content protection system 100 includes client device 110, network 120, and server 130. In various embodiments of the present invention, client device 110 may be a workstation, personal computer, personal digital assistant, mobile phone, or any other device capable of executing program instructions. In general, client device 110 is representative of any electronic device or combination of electronic devices capable of executing machine-readable program instructions, as described in greater detail with regard to FIG. 5. An individual utilizing client device 110 can access server 130 through network 120. Client device 110 includes application 112 and web browser 114. In exemplary embodiments, an individual can utilize application 112 and web browser 114 to access and utilize user interfaces to render data stored on storage device 132 of server 130 (e.g., email, documents, folders, etc.). Application 112 and web browser 114 support user authentication measures associated with content items on server 130.

In one embodiment, elements of content protection system 100 communicate through network 120. Network 120 can be, for example, a local area network (LAN), a telecommunications network, a wide area network (WAN) such as the Internet, or a combination of the three, and include wired, wireless, or fiber optic connections. In general, network 120 can be any combination of connections and protocols that will support communications between client device 110 and server 130 in accordance with exemplary embodiments of the present invention.

Server 130 includes storage device 132, configuration program 200 and content protection program 300. Server 130 a desktop computer, specialized computer server, or any other computer system known in the art. In certain embodiments, server 130 represents a computer system with programming utilizing clustered computers and components (e.g., database server computers, application server computers, etc.) that act as a single pool of seamless resources when accessed by elements of content protection system 100. In general, server 130 is representative of any programmed electronic device or combination of programmed electronic devices, as described in greater detail with regards to FIG. 5. In one embodiment, server 130 hosts content items securely in storage device 132 that can be accessed by client device 110 through network 120. Server 130 allows an individual utilizing application 112 and web browser 114 on client device 110 to access content items on storage device 132 through secure user interfaces.

Storage device 132 includes content items, and authentication information corresponding to the content items. Authentication information includes whether or not content items are protected, and authentication credentials corresponding to user interfaces associated with the content items. Storage device 132 can be implemented with any type of storage device that is capable of storing data that may be accessed and utilized by client device 110 and server 130, such as a database server, a hard disk drive, or flash memory. In other embodiments, storage device 132 can represent multiple storage devices within server 130. The content items included in storage device 132 that can be displayed in a user interface can be one or more documents, email, file folders, or other forms of data.

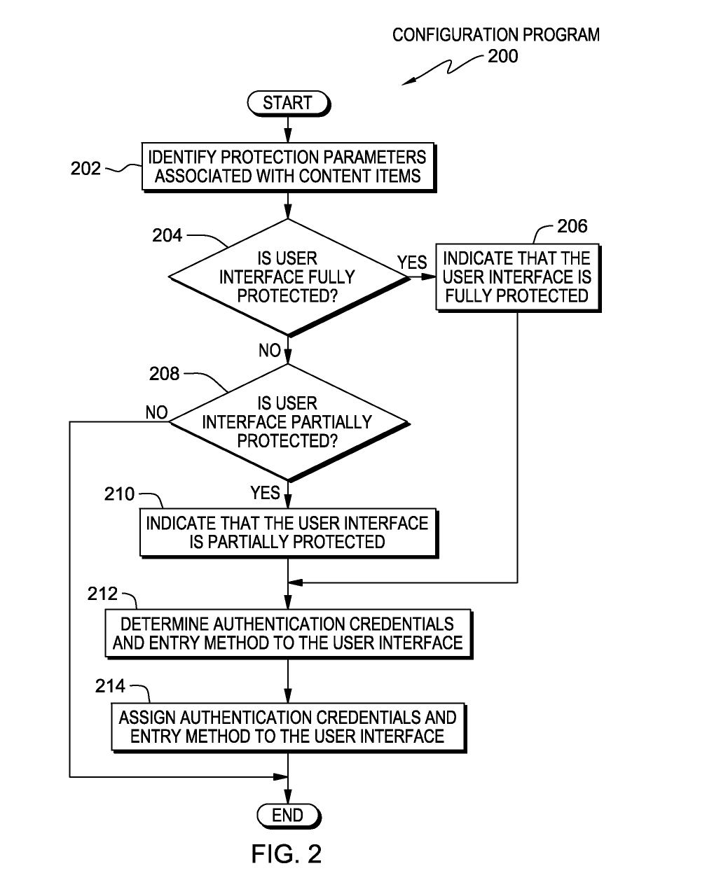

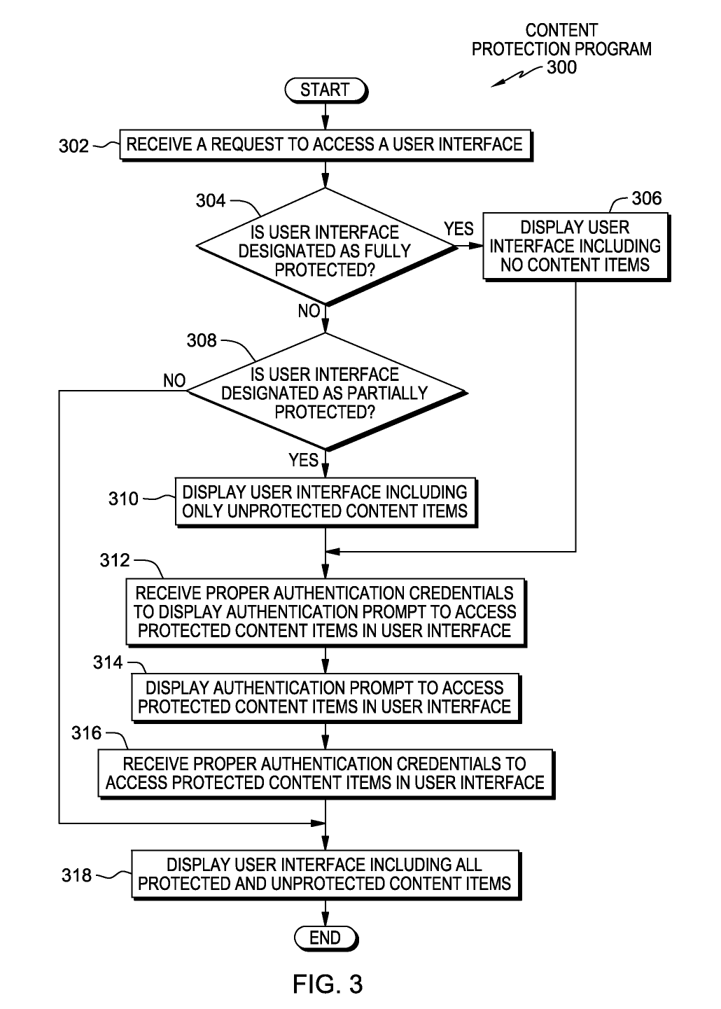

Content items stored in storage device 132 have associated information that indicates whether or not a content item is confidential. A content item that is confidential is tagged as protected or to be protected if possible, and a content item that is not confidential is tagged as unprotected. If a content item is tagged as protect if possible, and the content item is included in a secure user interface (i.e. password/authentication credential protected), then the content item is considered to be protected. In an example, an individual utilizing client device 110 receives an email that the sender has indicated is confidential. The confidential email is stored in storage device 132, and tagged as a protected content item. In another example, an individual utilizing client device 110 receives an email and indicates that the email is confidential (e.g., the individual email has been indicated to be confidential, or the sender of the email has been previously designated as confidential). The confidential email is stored in storage device 132, and tagged as a protected content item. Configuration program 200 configures a user interface that can include protected and unprotected content items. Configuration program 200 is discussed in greater detail with regards to FIG. 2. Content protection program 300 manages display of protected and unprotected content items in a user interface. Content protection program 300 is discussed in greater detail with regards to FIG. 3.

FIG. 2 is a flowchart depicting operational stops of configuration program 200 in accordance with an exemplary embodiment of the present invention. In one embodiment, configuration program 200 initiates when new content items associated with a user interface are added to storage device 132. The new content item can include an indication of whether or not the content item is confidential. In an example, storage device 132 stores emails that are accessed by application 112 or web browser 114 utilizing a user interface (i.e. email client). In this example, configuration program 200 initiates when new emails are received and stored in storage device 132. Configuration program 200 operates to configure whether a user interface is fully protected, partially protected, or unprotected corresponding to content items associated with the user interface.

In step 202, configuration program 200 identifies protection parameters associated with content items. In one embodiment, configuration program 200 identifies protection parameters associated with all content items in a user interface. Protection parameters (stored in storage device 132) include whether content items are tagged as protected, protect if possible, or unprotected. In exemplary embodiments, the content item included in a user interface can be a document, wherein parts of the document are designated (i.e. tagged) as confidential, and other parts of the document are designated as not confidential.

In decision step 204, configuration program 200 determines whether a user interface is fully protected. In one embodiment, configuration program 200 utilizes protection parameters associated with content items in the user interface (identified in step 202) to determine whether the user interface is fully protected. The user interface is fully protected if all content items included in the user interface have protection parameters indicating that the content items are protected. In an example, a user interface (e.g., an email client) includes emails that are stored in storage device 132. Configuration program 200 utilizes the protection parameters associated with the emails to determine that the user interface includes only protected emails, and therefore the user interface is fully protected.

In step 206, configuration program 200 indicates that the user interface is fully protected. In one embodiment, responsive to determining that the user interface is fully protected (in decision step 204), configuration program 200 stores an indication that the user interface is fully protected in storage device 132 associated with the user interface. In another embodiment, configuration program 200 can update a previously stored indication in storage device 132 to indicate that the user interface is fully protected. A fully protected user interface requires proper authentication credentials to access protected content items in the user interface (i.e. all content items in the user interface).

In decision step 208, configuration program 200 determines whether the user interface is partially protected. In one embodiment, responsive to determining that the user interface is not fully protected (in decision step 204), configuration program 200 utilizes protection parameters associated with content items in the user interface (identified in step 202) to determine whether the user interface is partially protected. The user interface is partially protected if the user interface includes content items with protection parameters indicating that the content items are protected and content items with protection parameters indicating that the content items are unprotected. In an example, a user interface (e.g., an email client) includes emails that are stored in storage device 132. Configuration program 200 utilizes the protection parameters associated with the emails to determine that the user interface includes protected and unprotected emails, and therefore the user interface is partially protected.

In step 210, configuration program 200 indicates that the user interface is partially protected. In one embodiment, responsive to determining that the user interface is partially protected (in decision step 208), configuration program 200 stores an indication that the user interface is partially protected in storage device 132 associated with the user interface. In another embodiment, configuration program 200 can update a previously stored indication in storage device 132 to indicate that the user interface is partially protected. A partially protected user interface requires proper authentication credentials to access protected content items in the user interface.

In step 212, configuration program 200 determines authentication credentials and entry method to the user interface. After indicating that the user interface is fully protected or partially protected (steps 206 and 210 respectively), configuration program 200 determines authentication credentials and entry method to the user interface. In one embodiment, an individual utilizing client device 110 inputs authentication credentials and entry method to configuration program 200. In another embodiment, authentication credentials and entry method are associated with an individual utilizing client device 110. Authentication credentials include a username and password combination, keyboard shortcuts (e.g., hotkey), biometric credentials, or other kinds of credential validation techniques. The determined authentication credentials include an authentication credential that initiates display of an authentication prompt, and an authentication credential enter into the authentication prompt. An entry method corresponds to an authentication credential and For example, configuration program 200 determines that for an individual utilizing client device 110 (e.g., through input from the individual, data associated with the individual etc.) an authentication credential of a keyboard shortcut (e.g., Shift+DRS) initiates display of an authentication prompt, and a username and password combination corresponds to the authentication prompt.

In step 214, configuration program 200 assigns authentication credentials and entry method to the user interface. In one embodiment, configuration program 200 assigns the authentication credentials and entry method determined in step 212 to the user interface. Configuration program 200 stores the authentication credentials and entry method in storage device 132 associated with the user interface.

FIG. 3 is a flowchart depicting operational steps of content protection program 300 in accordance with an exemplary embodiment of the present invention. In one embodiment, content protection program 300 initiates responsive to server 130 receiving a request to access content items in storage device 132 through a secure user interface that has been configured by configuration program 200. For example, an individual utilizing application 112 on client device 110 accesses content items on storage device 132 through a secure user interface configured by configuration program 200.

In step 302, content protection program 300 receives a request to access a user interface. In one embodiment, content protection program 300 receives the request from an individual utilizing application 112 or web browser 114 on client device 110. The user interface and associated content items are stored on storage device 132.

In decision step 304, content protection program 300 determines whether a user interface is designated as fully protected. In one embodiment, content protection program 300 accesses storage device 132, which includes an indication of whether or not the user interface is fully protected (from step 206 of configuration program 200).

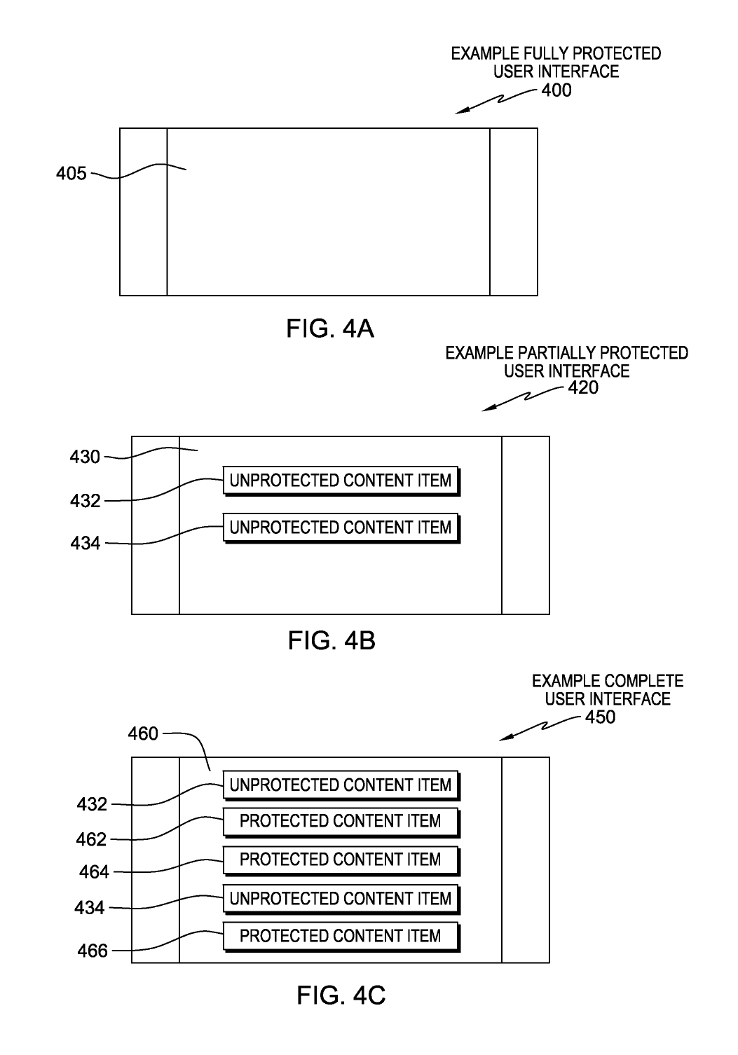

In step 306, content protection program 300 displays user interface including no content items. In one embodiment, responsive to determining that the user interface is designated as fully protected (in decision step 304), content protection program 300 displays an empty user interface. A fully protected user interface only includes content items with protection parameters indicating that the content items are protected. Since protected content items require user authentication to access, and the user interface does not include any unprotected content items, content protection program 300 displays an empty user interface. FIG. 4A depicts example fully protected user interface 400, which includes user interface display window 405. In exemplary embodiments, responsive to determining that the user interface is designated as fully protected (in decision step 304), content protection program 300 displays example fully protected user interface 400. User interface display window 405 is empty because example fully protected user interface 400 only includes protected content items. After displaying the fully protected user interface, content protection program 300 is able to receive authentication credentials (e.g., a keyboard shortcut from an individual utilizing client device 110).

In decision step 308, content protection program 300 determines whether the user interface is designated as partially protected. In one embodiment, responsive to determining that the user interface is not designated as fully protected (in decision step 308), content protection program 300 accesses storage device 132, which includes an indication of whether or not the user interface is fully protected (from step 210 of configuration program 200). If content protection program 300 determines that the user interface is not a partially protected user interface, then the user interface includes only unprotected content items.

In step 310, content protection program 300 displays user interface including only unprotected content items. In one embodiment, responsive to determining that the user interface is designated as partially protected (in decision step 308), content protection program 300 displays a user interface including only unprotected content items. A partially protected user interface includes both protected and unprotected content items, but content protection program 300 displays only unprotected content items because protected content items require user authentication to access. FIG. 4B depicts example partially protected user interface 420, which includes user interface display window 430, and unprotected content items 432 and 434. In exemplary embodiments, responsive to determining that the user interface is designated as partially protected, content protection program 300 displays example partially protected user interface 420. User interface display window 430 includes unprotected content items 432 and 434, which are content items that are not confidential and do not require user authentication to access. After displaying the partially protected user interface, content protection program 300 is able to receive authentication credentials (e.g., a keyboard shortcut from an individual utilizing client device 110).

Content protection program 300 displays only unprotected content items (or no content items in a fully protected user interface), which creates the appearance of an unsecured, open user interface that does not contain confidential data (i.e. protected content items). An authentication prompt is not initially displayed, giving an initial appearance that the user interface does not include confidential data that require authentication credentials to access. In exemplary embodiments, the display of a user interface that appears unsecured and without an authentication prompt discourages hacking attempts by not indicating that the user interface includes confidential data.

In step 312, content protection program 300 receives proper authentication credentials to display authentication prompt to access protected content items in user interface. In one embodiment, content protection program 300 receives authentication credentials from an individual utilizing client device 110, and verifies the authentication credentials with corresponding data stored in storage device 132. The authentication credentials are determined and assigned with the user interface in configuration program 200 (steps 212 and 214). In an example, content protection program 300 is displaying a fully or partially protected user interface (e.g., example fully protected user interface 400 and example partially protected user interface 420) that does not include a visual indication that an authentication credential can be input. An individual utilizing client device 110 enters a keyboard shortcut (e.g., Shift+DRS), content protection program 300 verifies that the keyboard shortcut is the proper authentication credential to display the authentication prompt to access protected content items in the user interface.

In step 314, content protection program 300 displays authentication prompt to access protected content items in the user interface. In one embodiment, responsive to receiving proper authentication credentials (in step 312), content protection program 300 displays an authentication prompt to access protected content items in the user interface. The authentication prompt can be any type of password entry screen or method of entering user authentication credentials.

In step 316, content protection program 300 receives proper authentication credentials to access protected content items in user interface. In one embodiment, content protection program 300 receives authentication credentials in the displayed authentication prompt (of step 314) from an individual utilizing client device 110, and verifies the authentication credentials with corresponding data stored in storage device 132. In exemplary embodiments, content protection program 300 receives authentication credentials into the displayed authentication prompt, which can be any type of password entry screen or method of entering user authentication credentials.

In step 318, content protection program 300 displays user interface including all protected and unprotected content items. In one embodiment, responsive to receiving proper authentication credentials to access protected content items in the user interface (in step 316), content protection program 300 displays the user interface including all associated content items (protected and unprotected). FIG. 4C depicts example complete user interface 450, which includes user interface display window 460, unprotected content items 432 and 434, and protected content items 462, 464 and 466. In exemplary embodiments, responsive to receiving proper authentication credentials to access protected content items in the user interface (in step 316), content protection program 300 displays example complete user interface 450. User interface display window includes unprotected content items 432 and 434 (content items that are not confidential and do not require user authentication to access), and protected content items (content items that are confidential and require user authentication to access). In an example, content protection program 300 displays example partially protected user interface 420. An individual utilizing client device 110 inputs proper authentication credentials to display the authentication prompt, and then enters proper authentication credentials to access protected content items in the authentication prompt (steps 312 through 316). Content protection program 300 displays example complete user interface 450, which includes unprotected content items 432 and 434 from example partially protected user interface 420 and protected content items 462, 464 and 466. Protected content items 462, 464 and 466 can be displayed since content protection program 300 has received proper authentication credentials.

FIG. 4A is an exemplary depiction of example fully protected user interface 400 in accordance with an exemplary embodiment of the present invention. Example fully protected user interface 400 includes user interface display window 405. In exemplary embodiments, user interface display window 405 is empty because example fully protected user interface 400 only includes protected content items.

FIG. 4B is an exemplary depiction of example partially protected user interface 420 in accordance with an exemplary embodiment of the present invention. Example partially protected user interface 420 includes user interface display window 430, which includes unprotected content items 432 and 434. Unprotected content items 432 and 434 are content items that are not confidential and do not require user authentication to access.

FIG. 4C is an exemplary depiction of example complete user interface 450 in accordance with an exemplary embodiment of the present invention. Example complete user interface 450 includes user interface display window 460, which includes unprotected content items 432 and 434, and protected content items 462, 464 and 466. In exemplary embodiments, example complete user interface 450 is displayed after proper authentication credentials have been provided. Unprotected content items 432 and 434 are content items that are not confidential and do not require user authentication to access (also displayed in example partially protected user interface 450). Protected content items 462, 464 and 466 are content items that are confidential and require user authentication to access.

Computing/processing devices client device 110 and server 130 include respective sets of internal components 800a,b, and external components 900a,b, illustrated in FIG. 5. Each of the sets of internal components 800a,b includes one or more processors 820, one or more computer-readable RAMs 822 and one or more computer-readable ROMs 824 on one or more buses 826, one or more operating systems 828 and one or more computer-readable tangible storage devices 830. The one or more operating systems 828, configuration program 200, content protection program 300 and storage device 132 (for server 130), application 112 and web browser 114 (for client device 110) are stored on one or more of the respective computer-readable tangible storage devices 830 for execution by one or more of the respective processors 820 via one or more of the respective RAMs 822 (which typically include cache memory). In the illustrated embodiment, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store but does not transmit a computer program and digital information.

Each set of internal components 800a,b also includes a R/W drive or interface 832 to read from and write to one or more portable computer-readable tangible storage devices 936 that can store but do not transmit a computer program, such as a CD-ROM, DVD, memory stick, magnetic tape, magnetic disk, optical disk or semiconductor storage device. Configuration program 200, content protection program 300 and storage device 132 (for server 130), application 112 and web browser 114 (for client device 110) can be stored on one or more of the respective portable computer-readable tangible storage devices 936, read via the respective R/W drive or interface 832 and loaded into the respective hard drive or semiconductor storage device 830.

Each set of internal components 800a,b also includes a network adapter or interface 836 such as a TCP/IP adapter card or wireless communication adapter (such as a 4G wireless communication adapter using OFDMA technology). Configuration program 200, content protection program 300 and storage device 132 (for server 130), application 112 and web browser 114 (for client device 110) can be downloaded to the respective computing/processing devices from an external computer or external storage device via a network (for example, the Internet, a local area network or other, wide area network or wireless network) and network adapter or interface 836. From the network adapter or interface 836, the programs are loaded into the respective hard drive or semiconductor storage device 830. The network may comprise copper wires, optical fibers, wireless transmission, routers, firewalls, switches, gateway computers and/or edge servers.

Each of the sets of external components 900a,b includes a display screen 920, a keyboard or keypad 930, and a computer mouse or touchpad 940. Each of the sets of internal components 800a,b also includes device drivers 840 to interface to display screen 920 for imaging, to keyboard or keypad 930, to computer mouse or touchpad 934, and/or to display screen for pressure sensing of alphanumeric character entry and user selections. The device drivers 840, R/W drive or interface 832 and network adapter or interface 836 comprise hardware and software (stored in storage device 830 and/or ROM 824).

The programs can be written in various programming languages (such as Java®, C+) including low-level, high-level, object-oriented or non object-oriented languages. Alternatively, the functions of the programs can be implemented in whole or in part by computer circuits and other hardware (not shown).

Based on the foregoing, a computer system, method and program product has been disclosed for protecting confidential content in a user interface. However, numerous modifications and substitutions can be made without deviating from the scope of the present invention. Therefore, the present invention has been disclosed by way of example and not limitation.

What is claimed is:

1. A method for protecting confidential information in a document displayed in a user interface, the method comprising:
a computer displaying in the user interface a non-confidential part of the document without displaying a confidential part of the document and without displaying any indication that the document includes the confidential part; and
while the computer displays the non-confidential part of the document without displaying the confidential part of the document and without displaying any indication that the document includes the confidential part, the computer receiving from a user authentication information and a request for display of the confidential part of the document, if any, and in response to the authentication information and the request, the computer displaying the confidential part of the document along with the non-confidential part of the document.

2. The method of claim 1, wherein the document is a list of emails received by the user, a list of documents, or a list of file folders.

3. The method of claim 1, wherein the computer receiving from the user authentication information and the request for display of the confidential part of the document, further comprises:
responsive to receiving from the user authentication information and the request for display of the confidential part of the document, the computer displaying an authentication information entry screen to the user.

4. The method of claim 1, wherein a user associated with the document identifies parts of the document as confidential and not confidential.

5. The method of claim 3, wherein the received user authentication information is a keyboard shortcut entered into the user interface.

6. The method of claim 1, wherein the computer will display an empty document in the user interface if the document in the user interface includes only confidential parts.

7. A computer program product for protecting confidential information in a document displayed in a user interface, the computer program product comprising:
one or more computer-readable storage devices and program instructions stored on the one or more computer-readable storage devices, the program instructions comprising:
program instructions to display in the user interface a non-confidential part of the document without displaying a confidential part of the document and without displaying any indication that the document includes the confidential part; and
program instructions, operable during the display of the non-confidential part of the document without the display of the confidential part of the document and without the display of any indication that the document includes the confidential part, to receive from a user authentication information and a request for display of the confidential part of the document, if any, and in response to the authentication information and the request, to display the confidential part of the document along with the non-confidential part of the document.

8. The computer program product of claim 7, wherein the document is a list of emails received by the user, a list of documents, or a list of file folders.

9. The computer program product of claim 7, wherein the program instructions to receive from the user authentication information and the request for display of the confidential part of the document, further comprises:
program instructions, responsive to receiving from the user the authentication information and the request for display of the confidential part of the document to display an authentication information entry screen to the user.

10. The computer program product of claim 7, wherein a user associated with the document identifies parts of the document as confidential and not confidential.

11. The computer program product of claim 9, wherein the received user authentication information is a keyboard shortcut entered into the user interface.

12. The computer program product of claim 7, further comprising program instructions, stored on the one or more storage devices, responsive to a request to display another document containing only a confidential part, to display the other document as empty of content without display of any indication that the other document includes a confidential part, and wherein the program instructions to display the confidential part are operable during the display of the empty document without the display of any indication that the other document includes a confidential part, to receive from a user authentication information and another request for display of the confidential part of the other document, if any, and in response to the authentication information and the other request, to display the confidential part of the other document.

13. A computer system for protecting confidential information in a document displayed in a user interface, the computer system comprising:
one or more computer processors, one or more computer-readable memories, one or more computer-readable storage devices, and program instructions stored on the one or more computer-readable storage devices for execution by the one or more processors via the one or more computer-readable memories, the program instructions comprising:
program instructions to display in the user interface a non-confidential part of the document without displaying a confidential part of the document and without displaying any indication that the document includes the confidential part; and
program instructions, operable during the display of the non-confidential part of the document without the display of the confidential part of the document and without the display of any indication that the document includes the confidential part, to receive from a user authentication information and a request for display of the confidential part of the document, if any, and in response to the authentication information and the request, to display the confidential part of the document along with the non-confidential part of the document.

14. The computer system of claim 13, wherein the document is a list of emails received by the user, a list of documents, or a list of file folders.

15. The computer system of claim 13, wherein the program instructions to receive from the user authentication information and the request for display of the confidential part of the document, further comprises:
program instructions, responsive to receiving from the user the authentication information and the request for display of the confidential part of the document, program instructions to display an authentication information entry screen to the user.

16. The computer system of claim 13, wherein a user associated with the document identifies parts of the document as confidential and not confidential.

17. The computer system of claim 15, wherein the received user authentication information is a keyboard shortcut entered into the user interface.

18. The computer system of claim 13, further comprising program instructions, stored on the one or more storage devices, responsive to a request to display another document containing only a confidential part, to display the other document as empty of content without display of any indication that the other document includes a confidential part, and wherein the program instructions to display the confidential part are operable during the display of the empty document without the display of any indication that the other document includes a confidential part, to receive from a user authentication information and another request for display of the confidential part of the other document, if any, and in response to the authentication information and the other request, to display the confidential part of the other document.
